(19) United States
(12) Patent Application Publication
(10) Pub. No.: US 2024/0229797 A1
(43) Pub. Date: Jul. 11, 2024

(54) Material Mover

(71) Applicant: PADDLEMOVER LLC, Columbia, MD (US)

(72) Inventor: Paul Anthony Johnson, Columbia, MD (US)

(73) Assignee: PADDLEMOVER LLC, Columbia, MD (US)

(21) Appl. No.: 18/407,224

(22) Filed: Jan. 8, 2024

Related U.S. Application Data
(60) Provisional application No. 63/437,911, filed on Jan. 9, 2023.

(51) Int. Cl. F04D 13/06; F04D 25/06; F04D 29/043; F04D 29/053; F16H 1/22

(52) U.S. Cl. CPC F04D 13/06; F04D 25/06; F04D 29/043; F04D 29/053; F16H 1/22

(57) ABSTRACT

A material mover assembly, comprising a chamber having an inlet and an outlet; a first paddle and a second paddle; and a gear assembly, wherein the first paddle is positioned in and configured to rotate circumferentially in the chamber, the second paddle is positioned in and configured to rotate circumferentially in the chamber, the gear assembly comprises an input drive shaft, a first output drive shaft, and a second output drive shaft, the first output drive shaft and the second output drive shaft are coaxial and concentric, the first output drive shaft is coupled to and configured to drive the first paddle, and the second output drive shaft is coupled to and configured to drive the second paddle, and a relative motion of the first paddle and the second paddle causes material to be pulled into the chamber via the inlet and pushed out of the chamber via the outlet in a forward direction.

The disclosure is related to devices and methods to move materials including gases, gas/particulate mixtures, liquids, particulates and the like.

### BACKGROUND

Movers, or pumps, or blowers, may be employed to “move” or “pump” a gas, a liquid, a gas/particulate mixture, a liquid/particulate mixture, a solid particulate, and the like. Applications exist in many fields, such as medical (e.g. breathing assistance, pumping blood/fluids, or delivery of medicinal sprays), ventilation (e.g. ventilation of buildings, vehicles, specialized clothing, or helmets), industrial (e.g. petrochemical, food, or material processing), consumer (e.g. toys, engines, compressors, refrigeration, hair dryers, vacuum cleaners, portable fans), and energy (e.g. hydroelectric, pressure storage/release, wind/tide/wave power generation if pump is driven to generate energy).

Desired are more efficient apparatuses and methods for moving gases, fluids, particulates, and mixtures thereof. Desired are apparatuses to move materials in forward and backward directions.

Also desired are efficient apparatuses that may also work in either direction as power generators wherein a moving material is employed to generate energy which may be used immediately or, alternatively stored as mechanical or electrical energy.

As just one example, a material may be pumped in one direction to a higher energy state, and optionally allowed to flow in the opposite direction to generate work.

### SUMMARY

Accordingly, disclosed is a material mover assembly, comprising a chamber having an inlet and an outlet; a first paddle and a second paddle; and a gear assembly, wherein the first paddle is positioned in and configured to rotate circumferentially in the chamber, the second paddle is positioned in and configured to rotate circumferentially in the chamber, the gear assembly comprises an input drive shaft, a first output drive shaft, and a second output drive shaft, the first output drive shaft and the second output drive shaft are coaxial and concentric, the first output drive shaft is coupled to and configured to drive the first paddle, and the second output drive shaft is coupled to and configured to drive the second paddle, and a relative motion of the first paddle and the second paddle causes material to be pulled into the chamber via the inlet and pushed out of the chamber via the outlet in a forward direction.

Also disclosed is a gear assembly comprising a first set of meshed gears; a second set of meshed gears; an input drive shaft; a first output drive shaft; and a second output drive shaft, wherein the first output drive shaft and the second output drive shaft are coaxial and concentric, the first set of gears is coupled to the input drive shaft and the first output drive shaft, and the second set of gears is coupled to the input drive shaft and the second output drive shaft.

### BRIEF DESCRIPTION OF THE DRAWINGS

The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1 depicts a paddle wheel flow sensor.

FIG. 2A, FIG. 2B, FIG. 2C and FIG. 2D show a material mover according to an embodiment.

FIG. 3 illustrates a gear assembly, according to an embodiment.

FIG. 4 shows a gear assembly, according to an embodiment.

FIG. 5 shows a gear assembly, according to an embodiment.

FIG. 6A illustrates a portion of a gear assembly, according to an embodiment.

FIG. 6B provides views of gear assembly portions, according to some embodiments.

FIG. 7 shows views of paddles in motion, according to some embodiments.

FIG. 8 provides a cross-section view and a top view of a pair of paddles, according to an embodiment.

FIG. 9 shows a cross-section view of a portion of a mover apparatus, according to an embodiment.

### DETAILED DISCLOSURE

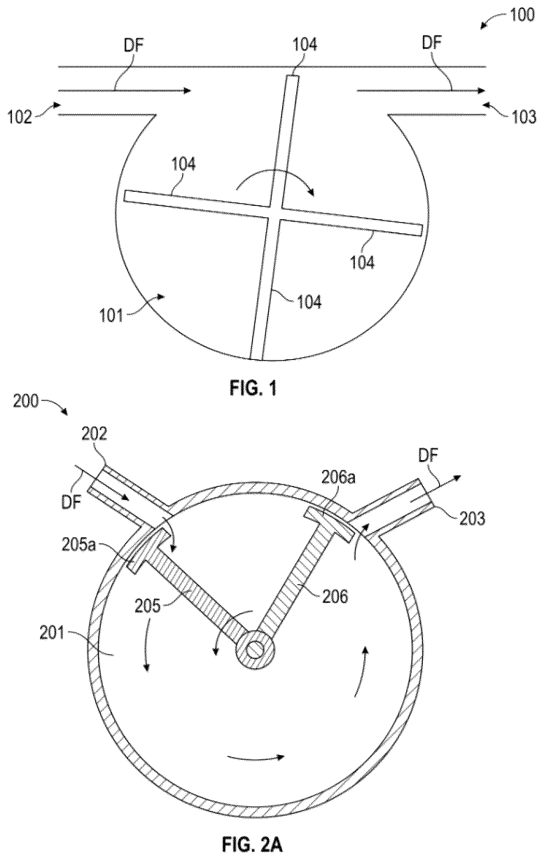

FIG. 1 shows a “paddle wheel” type flow sensor 100 in a cross-section view. Paddles 104 make up a paddle wheel and divide chamber 101 into four equal quadrants. In a flow sensor, liquid or gas will enter inlet 102, turn the paddle wheel and exit outlet 103. Rate of rotation of the paddle wheel may be used to determine a liquid or gas flow rate. Paddles 104 rotate together at an identical rate. Apparatus 100 will not be able to efficiently move a material into and out of chamber 101 in direction DF.

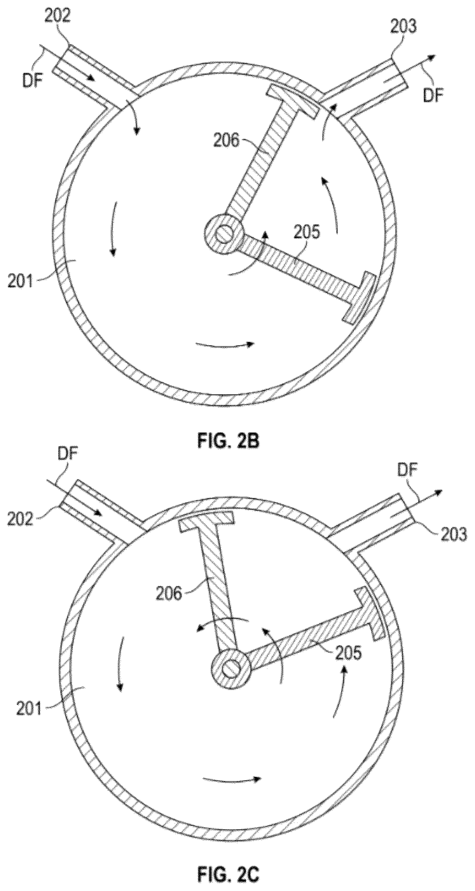

FIG. 2A, FIG. 2B, FIG. 2C and FIG. 2D show material mover apparatus 200, in cross-section view, in different stages of paddle rotation through a rotation cycle, according to some embodiments. A rotation cycle may mean one full 360 degree rotation. Chamber 201 comprises a substantially cylinder-like shape. Alternatively, chamber 201 may comprise a sphere-like shape. First paddle 205 and second paddle 206 are positioned in chamber 201, are configured to rotate counter-clockwise, and to move a material through inlet 202, through chamber 201, and to exit outlet 203. Paddles 205 and 206 have arc-shaped ends or “feet” 205a and 206a, configured to align with an interior surface of chamber 201. Feet 205a and 206a may increase efficiency of material movement through chamber 201. In some embodiments, a paddle may comprise a rigid material and a flexible end material. In other embodiment, a paddle and an end may comprise a same rigid or a same flexible material. Feet 205a and 206a are configured to open and close inlet 202 and outlet 203, acting as sleeve valves. In FIG. 2A and FIG. 2B, second paddle 206 is stationary (static) or moving slowly at about a one o'clock position as first paddle 205 rotates counter-clockwise. As first paddle 205 approaches second paddle 206 (FIG. 2B), second paddle 206 begins to rotate counter-clockwise. FIG. 2C shows both first paddle 205 and second paddle 206 rotating at the same time. First paddle 205 will come to rest or be moving slowly at about a one o'clock position and be stationary or almost stationary for a majority of a rotation cycle of second paddle 206, repeating the pattern. Apparatus 200 moves a material, for example a liquid or a gas, efficiently through inlet in forward direction DF, through chamber 201, and out outlet 203 in direction DF. Inlet 202 and outlet 203 are radially aligned at an incident angle. In some embodiments, an assembly like 200 may comprise one or more further paddles, for example a third, and/or a fourth, and/or a fifth paddle.

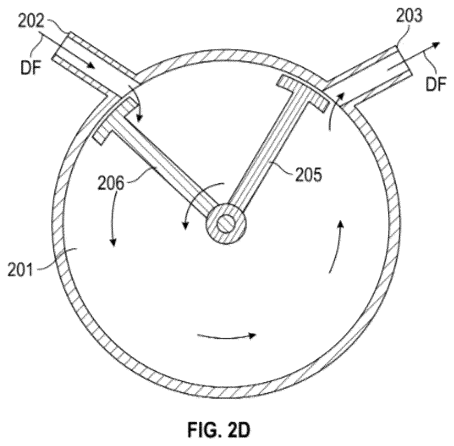

FIG. 3 shows gear assembly 325, from a side and a top view (with gears rotated 90 degrees), according to some embodiments. Gear assembly 325 comprises two sets oval-shaped meshed gears 326a/326b and 327a/327b, positioned 90 degrees out of phase. Gear assembly 325 is configured to be driven at a constant common rotational input speed by common drive shaft 328. Gear assembly 325 is configured to provide variable rotational output by a pair of concentric output shafts 329, comprising first output shaft 329a and second output shaft 329b. Assembly 325 is configured to provide speed variation cycles twice per input cycle per output stage. Concentric output shafts 329 are configured to couple to paddles positioned in a chamber. First output shaft 329a is configured to drive a first paddle and second output shaft 329b is configured to drive a second paddle. Output drive shafts 329a and 329b are coaxial and concentric.

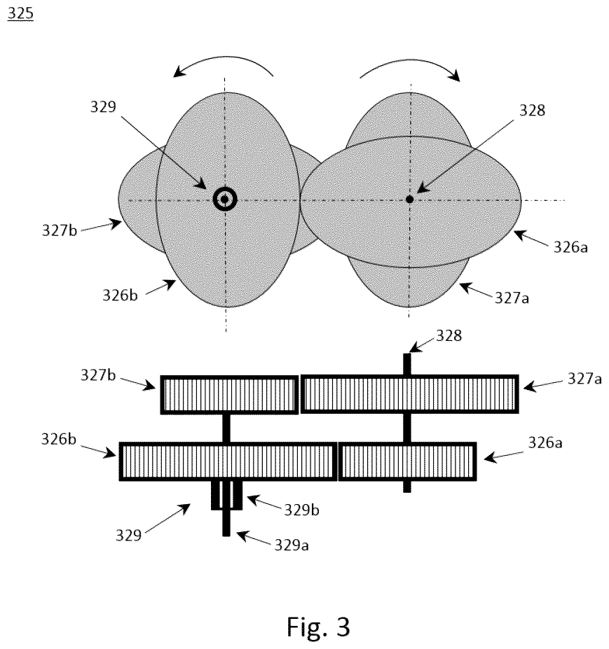

FIG. 4 shows gear assembly 425, from a side and a top view, according to some embodiments. Gear assembly 425 comprises two sets of meshed eccentric round gears 426a/426b and 427a/427b, positioned 180 degrees apart from each other. Gear assembly 425 is configured to be driven at a constant common rotational input speed by common drive shaft 428. Gear assembly 425 is configured to provide variable rotational output by a pair of concentric output shafts 429, comprising first output shaft 429a and second output shaft 429b. Assembly 425 is configured to provide speed variation cycles once per input cycle per output stage. Concentric shafts 425 are configured to couple to paddles positioned in a chamber. First output shaft 429a is configured to drive a first paddle and second output shaft 429b is configured to drive a second paddle. Output drive shafts 429a and 429b are coaxial and concentric.

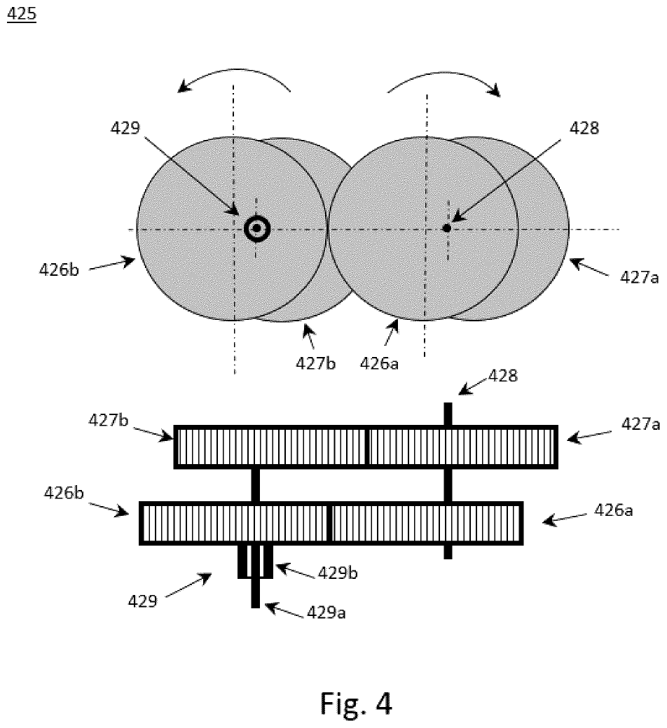

FIG. 5 shows gear assembly 525, from a side and a top view, according to some embodiments. Gear assembly 525 comprises two sets of meshed eccentric oval-shaped gears 526a/526b and 527a/527b, positioned 90 degrees apart from each other. Gear assembly 525 is configured to be driven at a constant common rotational input speed by common drive shaft 528. Gear assembly 525 is configured to provide variable rotational output by a pair of concentric output shafts 529, comprising first output shaft 529a and second output shaft 529b. Assembly 525 is configured to provide speed variation cycles once per input cycle per output stage. Concentric shafts 525 are configured to couple to paddles positioned in a chamber. First output shaft 529a is configured to drive a first paddle and second output shaft 529b is configured to drive a second paddle. Output drive shafts 529a and 529b are coaxial and concentric.

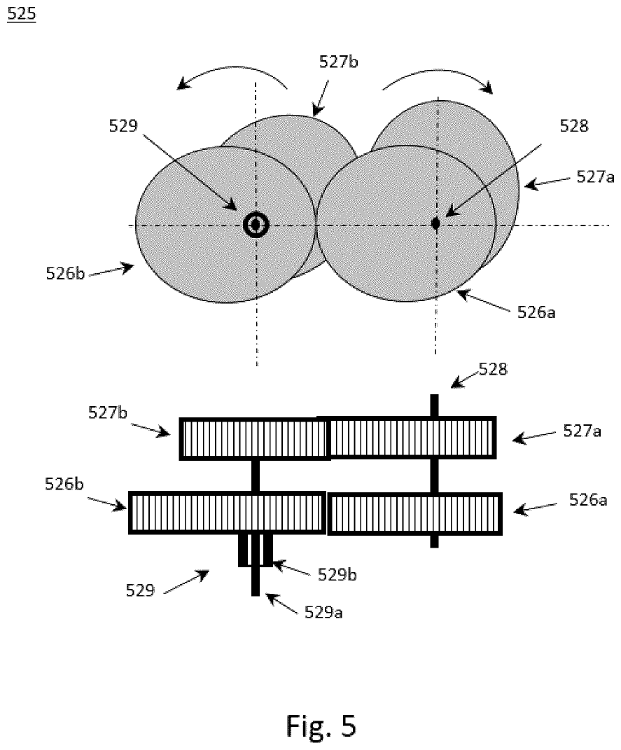

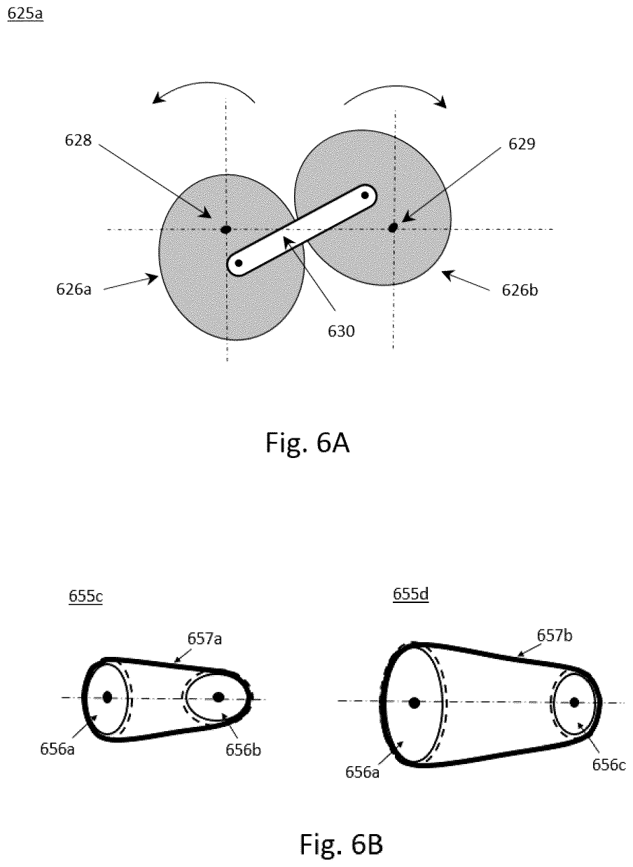

FIG. 6A shows gear assembly portion 625a, according to an embodiment. Gear assembly portion 625a comprises eccentric gear pair 626a/626b coupled to drive shaft 628 and output shaft 629. Eccentric gear pair 626a/626b comprises linkage 630 configured to hold pair 626a/626b together and to prevent any disengagement, with any linkage bearing clearance being designed so as to be a small fraction of gear tooth depth.

FIG. 6B shows gear assembly 655c (left) and 655d (right). Assembly 655c comprises oval gear wheels 656a and 656b, having a same size and a same number of gear teeth, each with a central axis. Gears 656a and 656b are joined with transmission belt 657a. As left side input gear 656a rotates 360 degrees at a constant angular velocity, right side output gear 656b will undergo a non-constant velocity rotation (speeding up/slowing down) with two maximum and two minimum speeds per cycle. A velocity increase gearing with a factor of 2 may be required at the output such that the output turns twice as fast so as to have only one maximum and one minimum in each of its two rotations to provide a desired paddle repeating pattern. Gear assembly 655d comprises oval gear wheels 656a and 656c, each having a central axis, wherein gear 656c is half the size of gear 656a, and having half the number of gear teeth, but with a same tooth profile. Gears 656a and 656c are joined with belt 657b. For each constant angular velocity rotation of gear 656a, gear 656c will make two rotations, and will speed up and slow down with one maximum and one minimum for each rotation, to provide a desired paddle repeating rotational pattern.

In some implementations, a belt may be employed in present assemblies. Advantages may include reduced stress on gear teeth, reduced backlash, less noise, and reduced clearance criticalities. In some embodiments, each of two paddle stages of a mover may have its own set of gear wheels, with left-side input wheels mounted at a 90 degree offset to each other. A careful selection of a wheel “ovality” may be required so as to have a constant belt length and rotational relationship to satisfy a mover operation while keeping an inter-axis constant. Alternatively, right-side wheels may be used as an input and left-side wheels as the output. Alternatively, wheels of different size ratios, oval definitions and number of wheels in combination may be employed. In some embodiments, eccentric wheels having off-center axes may be employed in some situations. Accordingly, a use of belts or chains with oval or non-circular gear wheels may be used on other applications in addition to a present mover. Accordingly, an embodiment of the disclosure may be directed to oval or non-circular gear wheels coupled together with a belt or chain. Belts or chains may comprise for instance a metal, a thermoplastic, a rubber, a composite, etc.

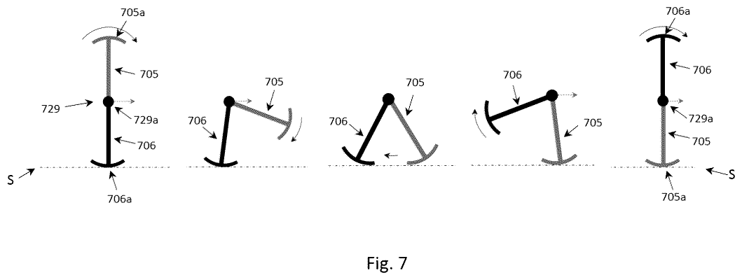

FIG. 7 shows paddles 705 and 706 in motion relative to surface S, according to some embodiments. Paddles, or “legs” 705 and 706 have arc-shaped feet 705a and 705b, configured to contact surface S. Paddles 705 and 706 are configured to be driven by concentric output shafts 729. In an embodiment, paddles 705 and 706 may be configured to drive a vehicle. Conventionally, a top of a standard vehicle wheel will move forward at twice the speed of a center of the wheel (connected to an axle), and a bottom of the wheel is simultaneously static. Only the portion in contact with a surface is transmitting force to propel the vehicle forward. In a present embodiment, from left to right, paddle, or leg, 705 is turning at a high speed about center point 729a. As paddle 705 approaches surface S, it will take over surface S contact from paddle 706, which increases rotational speed, repeating a cycle.

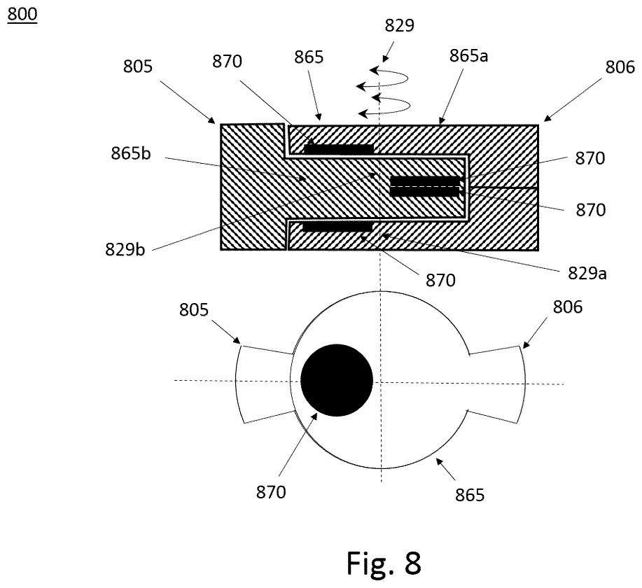

FIG. 8, top, shows a cross-section view of assembly portion 800, comprising a pair of paddles, 805 and 806, each as radial extensions to their central disc structures, 865b and 865a, respectively. FIG. 8, bottom, shows a top view of assembly portion 800, and central disc structure 865, according to an embodiment. Paddles 805 and 806 are configured to be driven on axis 829 by independent concentric inputs 829a and 829b. Output 829 is centrally positioned in drive disc 865. Assembly 865 comprises a “sandwich” structure, having outer portion 865a and inner portion 865b. Portions or “stages” 865a and 865b are symmetrical about the horizontal plane, with outer portion 865a straddling inner portion 865b. In this way, balance weights 870 may be positioned evenly above and below a horizontal plane, such that planes of inertia are assured to be coincident, thereby avoiding dynamic imbalance. It has been found that such an arrangement may provide for both radial and dynamic balance.

Dynamic imbalance in a system may waste energy in the form of vibrations or acoustics as well as causing undesired stresses and strains. Such effects increase with the square of speed, thus causing fast-increasing limits to performance as speed increases.

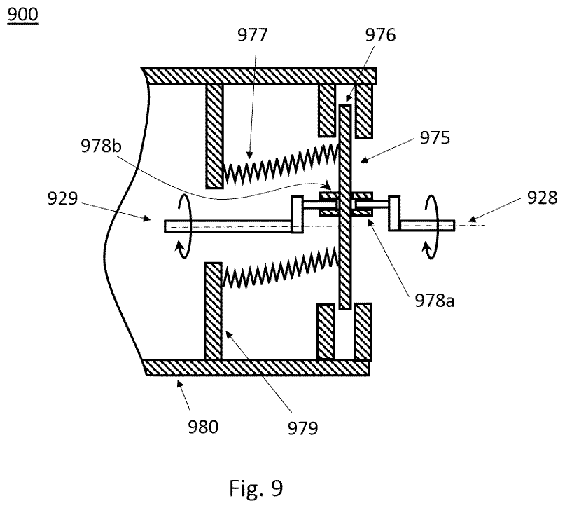

FIG. 9 provides a cross-section view of assembly portion 900, according to an embodiment. Walls 979 and 980, and bellows 977 define an interior and an exterior of assembly 900. Bellows assembly 975 comprises bellows 977 and transmission plate 976. Input drive 928 is configured to rotate output drive 929 by providing a translation movement to plate 976 (plate 976 is configured to translate along a circular path). Input 928 and output 929 are joined to plate 976 with connections 978a and 978b comprising bearings, for example ball bearings, journal bearings, etc. Accordingly, an assembly is provided which is configured to provide a seal or barrier to prevent sensitive materials from “leaking” from an interior of an assembly. Such a bellows assembly may be considered a “seal-less” transmission.

Dynamic seals are not suitable for some applications, especially where sensitive fluids are to be controlled (e.g. medical, food, corrosive, flammable, etc). A “seal-less” assembly is of interest. Magnetic transmission is known in pumps. The above-mentioned assembly alternatively employs a bellows or a flexible tubing. A bellows or tubing may comprise a steel, a thermoplastic, a rubber, or a composite, according to some embodiments. In some implementations, a direction of a bellows may be reversed, for example having a transmission plate positioned towards the interior rather than the exterior.

In other embodiments, an assembly may comprise two stages in series, each limited to move either up/down or left/right only by optional sliding features, controlled by vertical or horizontal slots. In such a way, any twisting torque on a bellows may be avoided, for example in cases where plate transmission bearings may not be free-moving enough to avoid local torque. A single-stage movement of a front plate in only one direction (up/down or left/right) might be engineered where a small angular offset and/or a non-concentric input/output axes offset is used, so as to encourage a direction of output motion on starting (analogous to shaded pole motors or a child's peddle car).

Accordingly, embodiments of the disclosure include belts or chains linked to oval or non-circular gears. Oval or non-circular gears may be connected by a link rod to prevent disconnecting. A seal-less transmission may be established using bellows where one end of the bellows is guided to translate in a circular path such that input and output cranks can transmit torque to each other without interrupting the internal/external sealing. A “sandwich” assembly having rotating or rotatable elements straddling each other may provide a manner in which both radially and dynamic balance is ensured by symmetry.

The disclosures of U.S. application Ser. No. 18/038,735, filed May 25, 2023, and international app. No. PCT/US2021/060904, filed Nov. 27, 2021, published as WO2022/115665, are hereby incorporated by reference in their entirety.

In some embodiments, any non-circular, oval, tapered, logarithmic, lobed, multi-lobed, and eccentric gear combinations may be employed to transmit power with variable rotational output speed. A gear assembly may operate with only two axes, a constant speed input drive along a first axis, and a pair of concentric output drives along a second axis. That is to say, variable rotational output speeds may be achieved with a constant rotational input speed with a gear assembly having only two axes.

In some embodiments, with two stages, relative approaching and distancing between paddles driven by output stages can achieve a variety of functions. In some embodiments, there may be singular or multiple output cycles for each input cycle, and, where multiple, the output cycles may be identical or varied within one input cycle. In an embodiment, further gearing may be used to resolve multiple output cycles to a lower number, as required. In an embodiment, adjustments of angle relationship between input stages or output stages may be employed to optimize for a given application. Alternatively, one set of non-standard gears can be used in parallel to a standard circular pair of gears such that one output is variable and the other is constant. In some embodiments, instead of two fixed axes, a distance between axes could be variable (e.g. sprung) such that a round gear could be used against a non-round gear to achieve a variable output cycle. In other embodiments, alternative non-geared arrangements such as sliding pin type mechanisms (e.g. Geneva wheels) or bar linkages (and linkage wheel combinations) could be used to give variable output speeds for a constant input speed.

Systems and methods of the disclosure may also include the following features. May incorporate glow plugs or spark plugs to create internal combustion to generate power. Gas/fuel burn upstream of inlets to achieve a constant high pressure input. Boilers upstream to achieve power generation from steam. Synthetic (wood gas) burning generators. Burn off gas (gas flaring) generators. In general, any source of increased pressure by constant or intermittent supply.

In some embodiments, present systems or methods may be employed for vehicle propulsion. In some embodiments, vehicle propulsion may occur on land and/or on or in water. Conventionally, for a vehicle, the top of a standard wheel is moving forward at twice the speed of the center of the wheel (connected to vehicle) and the bottom of the wheel is instantaneously static. Only the part in contact with the surface is transmitting force to propel the vehicle forward. Alternatively, using the gear assemblies described, movements below can be achieved:
1. The main drive axle speed and torque can still be constant.
2. Gearbox synchronization will assure that there is always surface contact.
3. The arcs only need to be long enough to maintain surface contact plus a little extra to allow for cases where the vehicle is moving uphill or downhill.
4. The arcs can be smaller or larger depending whether flat or uneven surfaces are being navigated, i.e. whether the application is that of ‘rolling’ or ‘stepping’.
5. Maximum torque will be applied when the legs (paddles) are at the surface, whereas maximum leg speed is during the period where there is no surface contact, i.e. where no torque is needed.
6. By variation of the overall pitch of the system (+/−0 to 180 degrees), looking along the drive axis, using longer arcs as appropriate, variation of velocity and torque ratios could be achieved.
7. For water surface applications, with the arcs replaced by paddles, propulsion can be achieved (analogues to a person swimming backstroke, where the swimmers arm in the air is doing no useful work and so the swimmer moves it quicker than the driving arm to get it back into the water to do work).
8. Power generation could be achieved where motion is taking place, driving the system.

In some embodiments, it is not required for one paddle to be static or nearly static during a rotation pattern. In some embodiments, a smoother, e.g. sinusoidal, relative rotation of paddles may be employed.

A chamber may comprise a single inlet and a single outlet, or may comprise multiple inlets and/or outlets. An inlet may be axially aligned with an outlet, or may not be axially aligned. In some embodiments, a chamber may comprise a substantially cylinder-like shape. In other embodiments, a chamber may comprise a substantially sphere-like shape.

In some embodiments, a mover assembly comprises a first paddle, a second paddle, and optionally one or more further paddles configured to be positioned in a chamber and to rotate circumferentially in the chamber.

A relative motion of the first paddle and the second paddle causes material to be pulled into the chamber via the inlet and pushed out of the chamber via the outlet in a forward direction. A term “relative motion” may mean a first paddle and/or a second paddle are configured to rotate at a variable speed.

In some embodiments, as a first paddle rotates, a second paddle is static or nearly static for at least a portion of a first paddle rotation cycle, and wherein as the second paddle rotates, the first paddle is static or nearly static for at least a portion of a second paddle rotation cycle.

In some embodiments, a first and/or second paddle may be configured to rotate at a varying rate of speed over a rotation cycle. A rotation cycle may mean a full 360 degree cycle of a single paddle, or may mean completion of a 360 degree rotation of all paddles of an assembly.

In some embodiments, one paddle may be configured to rotate at a constant rate of speed, while a further paddle may rotate at a varying rate of speed. In some embodiments, a first and a second paddle may both rotate at different, constant rates, and may switch off from fast to slow and from slow to fast, respectively, when one approaches the other.

In some embodiments, a paddle variable rotation rate may occur over a pre-determined set repeating pattern.

In some embodiments, a material mover assembly may comprise a drive shaft and/or a gear assembly. In some embodiments, a drive shaft may be driven via an electric motor. In some embodiments, a mover assembly may comprise a step motor or servo motor.

In some embodiments, varying rates of paddle rotation may be achieved with a clutch mechanism to engage/disengage a gear assembly. In other embodiments, varying rates of paddle rotation may be accomplished without engagement/disengagement of a gear assembly.

In some embodiments, a first paddle and a second paddle may be independently driven, or alternatively, may be conjointly driven.

In some embodiments, a paddle rotation direction may be configured to be reversible, a reversible rotation direction causing material to be pulled into the chamber via the outlet and pushed out of the chamber via the inlet in a reverse direction. In some embodiments, paddle rotation in a reverse direction may be configured to store energy, for instance to store energy in a battery or in the form of a spring. This may be achieved for example via a hand crank mechanism or a repetitive ratchet type mechanism. In some embodiments, a certain number of repetitive actuations may pump a material in a reverse direction, and a further actuation may release the material in a forward direction. In some embodiments, a reverse direction may be employed to store material for later release.

In some embodiments, a mover assembly may be configured to reverse a direction of operation. A mover assembly may be configured such that material may drive paddles to provide for storage of mechanical or electrical energy.

In some embodiments, driving a material in one direction may provide storing of energy which may be used to drive a material back in an opposite direction. For instance, if a person blows into the device, in some embodiments, the paddles will automatically sort themselves out to follow a cycle where the paddles move at variable relative speed to each other and therefore give an output (to what is the drive shaft when used in a pumping direction) at a near constant rotation speed.

In some embodiments, a mechanism may be employed to aid in storing energy, for example a spring or clockspring mechanism. In some embodiments, a storing mechanism may comprise a release feature, for instance a latch, or the like, configured to be actuated to release material energy causing material to be pulled into the chamber via the inlet and pushed out of the chamber via the outlet in a forward direction. In some embodiments, a mechanism may be configured to store mechanical and/or electrical energy and to release the energy on demand.

In some embodiments, a material mover assembly may be configured to provide substantially a same material flow rate in the forward and the reverse directions. In other embodiments, a material mover assembly may be configured to provide different material flow rates in the forward and the reverse directions. Such a configuration may be employed for instance for a patient having weak inhalation and normal exhalation.

In some embodiments, a material mover may be configured to provide same or different material volumes over a rotation cycle or over a number or rotation cycles in a forward and a reverse direction.

In some embodiments, an assembly may comprise one or more one-way valve to aid in adjusting, amplifying, or reducing material flow rates and/or volumes.

In some embodiments, a first paddle and/or a second paddle may comprise a flexible end or edge in contact with an interior surface of the chamber. This may aid in providing a highly efficient mover by reducing any back-flow. In some embodiments, a material may enter and exit a chamber at a substantially constant, steady flow rate with little turbulence. In some embodiments, a paddle may comprise a rigid material and a flexible end material. In other embodiments, a paddle and an end may comprise a same rigid or a same flexible material. In some embodiments, a flexible end or rigid end may comprise an “arc” shape to aid in opening or closing of inlets/outlets, acting as a sleeve valve.

In some embodiments, a present device or assembly may be employed for example in place of an air fan. A present device may be employed in a breathing apparatus, air ventilation system, an air pump, water pump, medical device (e.g. inhaler), space/diving helmet, refrigeration, etc. In an embodiment, a device may be employed to move air in one direction, wherein the air may be mixed with a medicine to be inhaled, and moved back in the opposite direction to be inhaled by a patient.

In some embodiments, two or more present material mover assemblies may be coupled in a parallel or series (i.e. “stacked”).

In some embodiments, a variable speed assembly comprises a drive wheel and rod, or wheel and rack, wherein the rod is coupled to the drive wheel and the outer gear or sun gear. In some embodiments, a rod may comprise a multi-rod assembly.

In some embodiments, paddle rotation patterns may be adjustable. For example rotation patterns may be adjusted to vary pressure/flow characteristics, for example high pressure compression at low flow rates or low pressure at high flow rates. For example, in a case where an arc-shaped paddle end closes an outlet in a static position, pressure may increase upon rotation of another paddle. Pressure may be controlled via relative position of one or more paddles.

In some embodiments, intentional backlash or similar slack of paddle positions may be intelligently used to help in re-positioning paddles with respect to inlets and outlets, used to optimize when changing pumping or energy generating directions. This re-positioning may be assisted by pressure, inertia, spring loading, friction or manual/automated actuation and might be constant in an application or temporary/intermittent depending on cycle position or whether in load change, speed change, start-up or slow down.

In some embodiments, an assembly may comprise a plurality of paddles configured to work in a “caterpillar”, or concerted “daisy-chain” way, wherein an assembly may comprise bypass cavities or tunnels wherein material may be pushed in and out with paddle feet acting to close and open the bypass cavities. Bypass cavities may be used to increase pressure in steps throughout a rotation cycle.

In some embodiments, a mover may drive a material in a first direction or a second direction, and may also act as an energy generator in a first or a second direction if driven by a material. In some embodiments, a first direction is opposite to a second direction.

Following are some non-limiting embodiments of the disclosure.

In a first embodiment, disclosed is a material mover assembly, comprising a chamber having an inlet and an outlet; a first paddle and a second paddle; and a gear assembly, wherein the first paddle is positioned in and configured to rotate circumferentially in the chamber, the second paddle is positioned in and configured to rotate circumferentially in the chamber, the gear assembly comprises an input drive shaft, a first output drive shaft, and a second output drive shaft, the first output drive shaft and the second output drive shaft are coaxial and concentric, the first output drive shaft is coupled to and configured to drive the first paddle, and the second output drive shaft is coupled to and configured to drive the second paddle, and a relative motion of the first paddle and the second paddle causes material to be pulled into the chamber via the inlet and pushed out of the chamber via the outlet in a forward direction.

In a second embodiment, disclosed is a mover assembly according to embodiment 1, wherein the first paddle and the second paddle rotate at a varying rate. In a third embodiment, disclosed is a mover assembly according to embodiment 2, wherein as the first paddle rotates, the second paddle is static or nearly static for at least a portion of a first paddle rotation cycle, and wherein as the second paddle rotates, the first paddle is static or nearly static for at least a portion of a second paddle rotation cycle. In a fourth embodiment, disclosed is a mover assembly according to any of the preceding embodiments, wherein the varying rate is configured to occur in a repeating pattern over a rotation cycle.

In a fifth embodiment, disclosed is a mover assembly according to any of the preceding embodiments, wherein the gear assembly is configured to couple to a constant speed electric motor to drive the input drive shaft.

In a sixth embodiment, disclosed is a mover assembly according to any of the preceding embodiments, wherein the gear assembly comprises a first set of gears coupled to the input drive shaft and the first output drive shaft, and a second set of gears coupled to the input drive shaft and the second output drive shaft. In a seventh embodiment, disclosed is a mover assembly according to embodiment 6, wherein the input drive shaft is positioned along a first axis, and the first and second output drive shafts are positioned along a second axis.

In an eighth embodiment, disclosed is a mover assembly according to any of the preceding embodiments, wherein the gear assembly comprises two sets of oval-shaped gears. In a ninth embodiment, disclosed is a mover assembly according to any of embodiments 1 to 7, wherein the gear assembly comprises two sets of round eccentric gears. In a tenth embodiment, disclosed is a mover assembly according to any of embodiments 1 to 7, wherein the gear assembly comprises two sets of oval-shaped eccentric gears.

In an eleventh embodiment, disclosed is a mover assembly according to embodiment 4, wherein the rotation cycle repeating pattern is adjustable.

In a twelfth embodiment, disclosed is a mover assembly according to embodiment 1, wherein a paddle rotation direction is reversible, the reversible rotation direction configured to pull material into the chamber via the outlet and to push out of the chamber via the inlet in a reverse direction. In a thirteenth embodiment, disclosed is a mover assembly according to embodiment 12, wherein paddle rotation is driven by material flow to create mechanical or electrical energy. In a fourteenth embodiment, disclosed is a mover assembly according to embodiment 12, comprising a mechanism configured to store energy and configured to release the energy on demand.

In a fifteenth embodiment, disclosed is a mover according to embodiment 1, wherein the first paddle and/or the second paddle comprises a flexible end in contact with an interior surface of the chamber.

In a sixteenth embodiment, disclosed is a mover according to embodiment 1, wherein the material is one or more of a gas, a gas/particulate mixture, a liquid, or a particulate solid.

In a seventeenth embodiment, disclosed is a gear assembly comprising a first set of meshed gears; a second set of meshed gears; an input drive shaft; a first output drive shaft; and a second output drive shaft, wherein the first output drive shaft and the second output drive shaft are coaxial and concentric, the first set of gears is coupled to the input drive shaft and the first output drive shaft, and the second set of gears is coupled to the input drive shaft and the second output drive shaft.

In an eighteenth embodiment, disclosed is a gear assembly according to embodiment 17, wherein the first set of gears and the second set of gears comprise oval-shaped gears. In a nineteenth embodiment, disclosed is a gear assembly according to embodiment 17, wherein first set of gears and the second set of gears comprise round eccentric gears. In a twentieth embodiment, disclosed is a gear assembly according to embodiment 17, wherein the first set of gears and the second set of gears comprise oval-shaped eccentric gears.

In a twenty-first embodiment, disclosed is a gear assembly according to any of embodiments 17 to 20, wherein the first set of meshed gears and/or the second set of meshed gears are coupled together with a linkage. In a twenty-second embodiment, disclosed is a gear assembly according to any of embodiments 17 to 21, wherein the first output drive shaft and the second output drive shaft are configured to provide variable rotational output speeds with a constant input rotational speed.

In a twenty-third embodiment, disclosed is a vehicle propulsion system comprising a first paddle and a second paddle; and a gear assembly, wherein the first paddle is positioned in and configured to rotate circumferentially, the second paddle is positioned in and configured to rotate circumferentially, the gear assembly comprises an input drive shaft, a first output drive shaft, and a second output drive shaft, the first output drive shaft and the second output drive shaft are coaxial and concentric, the first output drive shaft is coupled to and configured to drive the first paddle, and the second output drive shaft is coupled to and configured to drive the second paddle, and a relative motion of the first paddle and the second paddle is configured to propel a vehicle.

In a twenty-fourth embodiment, disclosed is a vehicle propulsion system according to embodiment 23, configured to propel a vehicle on land and/or on or in water. In a twenty-fifth embodiment, disclosed is a vehicle propulsion system according to embodiments 23 or 24, as modified by any of embodiments 2 to 16, and or comprising a gear assembly according to any of embodiments 17 to 22.

The term “adjacent” may mean “near” or “close-by” or “next to”.

The term “coupled” means that an element is “attached to” or “associated with” another element. Coupled may mean directly coupled or coupled through one or more other elements. An element may be coupled to an element through two or more other elements in a sequential manner or a non-sequential manner. The term “via” in reference to “via an element” may mean “through” or “by” an element. Coupled or “associated with” may also mean elements not directly or indirectly attached, but that they “go together” in that one may function together with the other.

The term “flow communication” means for example configured for liquid or gas flow there through and may be synonymous with “fluidly coupled”. The terms “upstream” and “downstream” indicate a direction of gas or fluid flow, that is, gas or fluid will flow from upstream to downstream.

The term “towards” in reference to a of point of attachment, may mean at exactly that location or point or, alternatively, may mean closer to that point than to another distinct point, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, or ±10%. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, or ±10% of the definition; for example the term “substantially perpendicular” may mean the 90° perpendicular angle may mean “about 90°”. The term “generally” may be equivalent to “substantially”.

The term “nearly” may mean “almost”.

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

1. A material mover assembly, comprising
a chamber having an inlet and an outlet;
a first paddle and a second paddle; and
a gear assembly,
wherein
the first paddle is positioned in and configured to rotate circumferentially in the chamber,
the second paddle is positioned in and configured to rotate circumferentially in the chamber,
the gear assembly comprises an input drive shaft, a first output drive shaft, and a second output drive shaft,
the first output drive shaft and the second output drive shaft are coaxial and concentric,
the first output drive shaft is coupled to and configured to drive the first paddle, and the second output drive shaft is coupled to and configured to drive the second paddle, and
a relative motion of the first paddle and the second paddle causes material to be pulled into the chamber via the inlet and pushed out of the chamber via the outlet in a forward direction.

2. The mover assembly according to claim 1, wherein the first paddle and the second paddle rotate at a varying rate.

3. The mover assembly according to claim 2, wherein as the first paddle rotates, the second paddle is static or nearly static for at least a portion of a first paddle rotation cycle, and wherein as the second paddle rotates, the first paddle is static or nearly static for at least a portion of a second paddle rotation cycle.

4. The mover assembly according to claim 2, wherein the varying rate is configured to occur in a repeating pattern over a rotation cycle.

5. The mover assembly according to claim 1, wherein the gear assembly is configured to couple to a constant speed electric motor to drive the input drive shaft.

6. The mover assembly according to claim 1, wherein the gear assembly comprises a first set of gears coupled to the input drive shaft and the first output drive shaft, and a second set of gears coupled to the input drive shaft and the second output drive shaft.

7. The mover assembly according to claim 6, wherein the input drive shaft is positioned along a first axis, and the first and second output drive shafts are positioned along a second axis.

8. The mover assembly according to claim 1, wherein the gear assembly comprises two sets of oval-shaped gears.

9. The mover assembly according to claim 1, wherein the gear assembly comprises two sets of round eccentric gears.

10. The mover assembly according to claim 1, wherein the gear assembly comprises two sets of oval-shaped eccentric gears.

11. The mover assembly according to claim 4, wherein the rotation cycle repeating pattern is adjustable.

12. The mover assembly according to claim 1, wherein a paddle rotation direction is reversible, the reversible rotation direction configured to pull material into the chamber via the outlet and to push out of the chamber via the inlet in a reverse direction.

13. The mover assembly according to claim 12, wherein paddle rotation is driven by material flow to create mechanical or electrical energy.

14. The mover assembly according to claim 12, comprising a mechanism configured to store energy and configured to release the energy on demand.

15. The mover according to claim 1, wherein the first paddle and/or the second paddle comprises a flexible end in contact with an interior surface of the chamber.

16. The mover according to claim 1, wherein the material is one or more of a gas, a gas/particulate mixture, a liquid, or a particulate solid.

17. A gear assembly comprising
a first set of meshed gears;
a second set of meshed gears;
an input drive shaft;
a first output drive shaft; and
a second output drive shaft,
wherein
the first output drive shaft and the second output drive shaft are coaxial and concentric,
the first set of gears is coupled to the input drive shaft and the first output drive shaft, and
the second set of gears is coupled to the input drive shaft and the second output drive shaft.

18. The gear assembly according to claim 17, wherein the first set of gears and the second set of gears comprise oval-shaped gears.

19. The gear assembly according to claim 17, wherein first set of gears and the second set of gears comprise round eccentric gears.

20. The gear assembly according to claim 17, wherein the first set of gears and the second set of gears comprise oval-shaped eccentric gears.
